(19) United States
(12) Patent Application Publication
(10) Pub. No.: US 2010/0250333 A1
(43) Pub. Date: Sep. 30, 2010

(54) OPTIMIZING CASHBACK RATES

(75) Inventors: RAKESH AGRAWAL, SAN JOSE, CA (US); LAWRENCE WILLIAM COLAGIOVANNI, KIRKLAND, WA (US); ARUN KUMAR SACHETI, SAMMAMISH, WA (US); SAMUEL IEONG, PALO ALTO, CA (US); RAJA PALANI VELU, MANLIUS, NY (US)

Correspondence Address: SHOOK, HARDY & BACON L.L.P.;(MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, Redmond, WA (US)

(21) Appl. No.: 12/415,683

(22) Filed: Mar. 31, 2009

(51) Int. Cl. G06Q 10/00; G06N 5/02; G06Q 30/00

(52) U.S. Cl. 705/10; 706/52; 705/14.34

(57) ABSTRACT

A method, system, and medium are provided for determining optimal sales rebate rates. Historical data, including sales data, price data, and rebate data are received, along with ongoing current data from current rebate transactions. Changes across the spectrum of data are determined and calculations are used to obtain an optimal sales rebate rate for one of more products or services utilizing statistical models, including but not limited to, a linear rebate rate model and a logarithmic-linear rebate rate model for one or more products or services. A mathematical analysis determines the appropriate model to use to obtain the optimal sales rebate rate. The optimal sales rebate rate may be applied to computing or non-computing environments, in whole or as a combination of both computing and non-computing environments.

### BACKGROUND

Many merchants have taken advantage of enticing prospective customers to buy their products or services by offering discounts or rebates towards the purchase of their products or services. For many years, this was utilized through newspaper or flyer coupons. More recently, Internet advertising by merchants has offered discounts or rebates. As one example, a merchant may pay a hosting website each time a consumer clicks on or selects the merchant's posted advertisement. Some of the money from consumer clicks may then be returned to the consumers, from the hosting website, in the form of cashback or rebates.

Determining the amount of rebate or whether to offer a rebate is typically determined after the fact, in reaction to events as they occur. An estimate based upon prior rebate activities is established, then manually adjusted, as necessary. However, the major thrust of a sales drive may be over before it becomes apparent that a rebate offer was not very effective or was too generous.

### SUMMARY

Embodiments of the invention are defined by the claims below. A high-level overview of various embodiments of the invention is provided to introduce a summary of the systems, methods, and media that are further described in the Detailed Description section below. This Summary is neither intended to identify key features or essential features of the claimed subject matter, nor is it intended to be used as an aid in isolation to determine the scope of the claimed subject matter.

Embodiments of the invention utilize a statistical framework to estimate the factors that affect consumers relative to sales rebates offered for different products and services and to determine optimal sales rebates that satisfy certain business goals, such as limiting the total payout to a given budget, in view of such factors. Historical data, e.g., from transaction logs, is received and analyzed in order to determine the influence of changes in demand, price, sales rebate rates, and other factors, such as seasonality, on sales of the products/services. Ongoing transaction data, particularly sales rebate transaction data is also continually received (for instance, at regularly scheduled intervals), and is used to improve the statistical framework. Historical data from, e.g., click logs, is used to estimate the gross earnings to be received from merchant advertising using an interconnected computing network, such as the Internet.

Using this data, a statistical model, such as a linear estimation model or a logarithmic-linear estimation model is utilized to determine demand for the product/service as a function of sales rebate rates, price, and the like. Regression analysis is one method which can be applied to learn the relationship between demand, sales rebate rates, and price for the model. The optimal sales rebate rate is then determined for each of the products/services. An iteration process, such as second order cone programming or convex programming can be utilized to obtain the optimal rebate rates.

Cashback operations may then be instituted in accordance with the optimal sales rebate rate determined for a particular product or service. Data from cashback operations may be continually fed back in order to provide up-to-date estimation parameters and optimal sales rebate rates as new data becomes available. The feedback data from cashback operations provides a means to maximize sales or profits, as well as achieve other objectives, as explained in detail hereinafter.

### BRIEF DESCRIPTION OF THE DRAWINGS

Illustrative embodiments of the invention are described in detail below, with reference to the attached drawing figures, which are incorporated by reference herein, and wherein:

FIG. 1 is a block diagram illustrating an exemplary operating environment used in accordance with embodiments of the invention;

FIG. 2 is a block diagram illustrating the basic functionality of embodiments of the invention;

FIG. 3 is a block diagram of a computer system configured to determine optimal sales rebate rates, in accordance with the embodiments of the invention; and

FIG. 4 is a flow diagram illustrating a method for determining optimal sales rebates, in accordance with an embodiment of the invention.

### DETAILED DESCRIPTION

Embodiments of the invention provide systems, methods and computer-readable storage media for optimizing cashback or sales rebate rates. This Detailed Description satisfies the applicable statutory requirements. The terms “step,” “block,” etc. might be used herein to connote different acts of methods employed, but the terms should not be interpreted as implying any particular order, unless the order of individual steps, blocks, etc. is explicitly described. Likewise, the term “module,” etc. might be used herein to connote different components of systems employed, but the terms should not be interpreted as implying any particular order, unless the order of individual modules, etc. is explicitly described.

Throughout the description of different embodiments of the invention, several acronyms and shorthand notations are used to aid the understanding of certain concepts pertaining to the associated systems, methods and computer-readable media. These acronyms and shorthand notations are intended to help provide an easy methodology for communicating the ideas expressed herein and are not meant to limit the scope of any embodiment of the invention.

Embodiments of the invention include, without limitation, methods, systems, and sets of instructions embodied on one or more computer-readable media. Computer-readable media include both volatile and nonvolatile media, removable and non-removable media, and media readable by a database and various other network devices. Computer-readable media comprise computer storage media and communication media. By way of example, and not limitation, computer-readable media comprise media implemented in any method or technology for storing information. Examples of stored information include computer-useable instructions, data structures, program modules, and other data representations. Media examples include, but are not limited to, information-delivery media, random access memory (RAM), read-only memory (ROM), electrically erasable programmable read-only memory (EEPROM), flash memory or other memory technology, compact-disc read-only memory (CD-ROM), digital versatile discs (DVD), holographic media or other optical disc storage, magnetic cassettes, magnetic tape, magnetic disk storage, and other magnetic storage devices. These examples of media can be configured to store data momentarily, temporarily, or permanently. The computer readable media include cooperating or interconnected computer readable media, which exist exclusively on a processing system or distributed among multiple interconnected processing systems that may be local to, or remote from, the processing system. Communication media can be configured to embody computer-readable instructions, data structures, program modules or other data in an electronic data signal, and includes any information delivery media. By way of example, and not limitation, communication media includes wired media such as a wired network or direct-wired connection, and wireless media such as acoustic, radio frequency (RF), infrared and other wireless media. Combinations of any of the above are also included within the scope of computer-readable media.

An embodiment of the invention may be described in the general context of computer code or machine-useable instructions, including computer-executable instructions such as program modules, being executed by a computer or other machine. Generally, program modules including routines, programs, objects, components, data structures, and the like refer to code that perform particular tasks or implement particular data types. Embodiments described herein may be implemented using a variety of system configurations, including handheld devices, consumer electronics, general-purpose computers, more specialty computing devices, etc. Embodiments described herein may also be implemented in distributed computing environments, using remote-processing devices that are linked through a communications network.

As previously stated, embodiments of the invention utilize a statistical framework to estimate the factors that affect consumers relative to sales rebates offered for different products and services and to determine optimal sales rebates within a given budget in view of such factors. An infrastructure operates as an advertising domain for a number of merchants with products and/or services to offer for sale. The advertising could occur by way of an interconnected computing network, such as the Internet or an internal organizational network. Historical and ongoing data is received and utilized to determine the influence of changes in price, rebate rates, and other factors (such as seasonality) on sales of the products/services, and to estimate the gross earnings to be received from merchant advertising. Demand for the product/service as a function of sales rebate rates, price, and the like is estimated and optimal sales rebate rates are determined for each of the products/services. The optimal sales rebate rates are determined such that sales of or profits from the products/services are maximized while at the same time, certain business goals are met. As an example, the available rebate budget is not exceeded, and/or the sales rebate rates lie in certain ranges of values. These business goals are collectively called constraints, and constraints are satisfied when business goals are met.

Accordingly, in one embodiment, the present invention is directed to one or more computer-readable storage media that, when executed by a computing device, perform a method for determining optimal sales rebate rates. The method includes receiving one or more of historical sales data, historical price data, and historical rebate data for a plurality of products advertised by a merchant; determining patterns in price rates and sales rebate rates using the one or more of the historical sales data, the historical price data, and the historical rebate data; estimating gross earnings to be received from the merchant advertising the plurality of products; calculating a rebate budget as a portion of the estimated gross earnings; and determining an optimal sales rebate rate for each of the plurality of products. The optimal sales rebate rate for each of the plurality of products is determined such that sales of or profits from the plurality of products are maximized and the constraints are satisfied.

In another embodiment, the present invention is directed to a computer system having a processor, memory and data storage subsystems. The computer system includes a data store, a demand prediction computing component and an optimization computing component. The data store includes historical sales data, historical price data, and historical rebate data from one or more merchants. The demand prediction computing component is configured to determine a relationship between prices, rebates offered, and quantity of products sold utilizing the historical sales data, the historical price data, and the historical rebate data in the data store. The optimization computing component comprises a gross earnings determining component and a rebate budget determining component, and is configured to determine an optimal sales rebate rate for each of the plurality of products.

In yet another embodiment, the present invention is directed to a computer-implemented method for determining optimal sales rebate rates. The method includes receiving historical sales data, historical price data, and historical rebate data for a plurality of products advertised by a merchant; determining (utilizing a first computer process) a relationship between prices, rebates offered, and quantity of products/services sold utilizing a regression analysis; estimating (utilizing a second computer process) gross earnings to be received from the merchants advertising the plurality of products; calculating (utilizing a third computer process) a rebate budget as a portion of the estimated gross earnings; and determining (utilizing a fourth computer process) an optimal sales rebate rate for each of the plurality of products utilizing second order cone programming or convex programming. The optimal sales rebate rate for each of the plurality of products is determined such that sales of or profits from the plurality of products are maximized and the rebate budget is not exceeded.

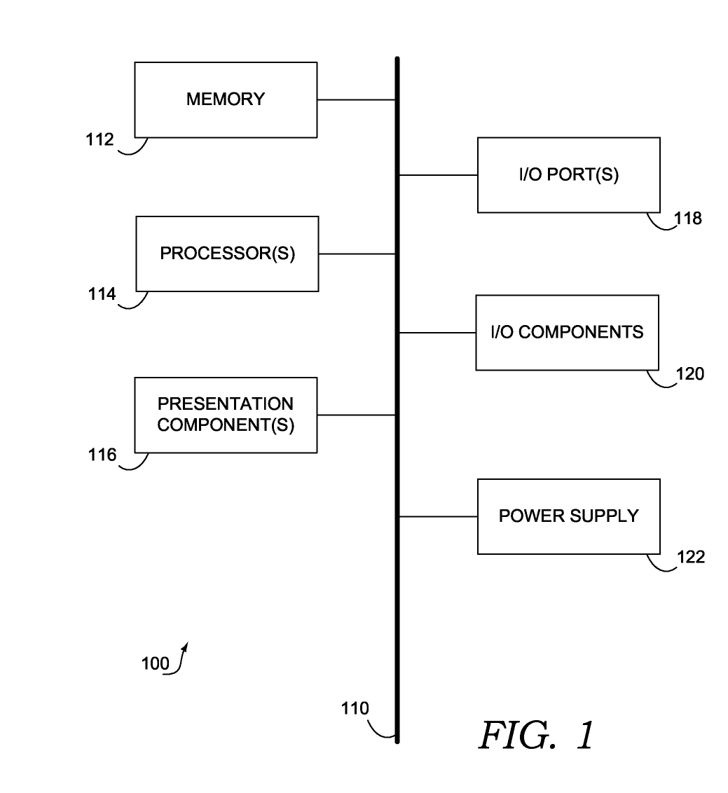

Having briefly described a general overview of the embodiments herein, an exemplary computing device is described below. Referring initially to FIG. 1, an exemplary operating environment for implementing embodiments of the present invention is shown and designated generally as computing device 100. The computing device 100 is but one example of a suitable computing environment and is not intended to suggest any limitation as to the scope of use or functionality of the invention. Neither should the computing device 100 be interpreted as having any dependency or requirement relating to any one or combination of components illustrated. In one embodiment, the computing device 100 is a conventional computer (e.g., a personal computer or laptop).

The computing device 100 includes a bus 110 that directly or indirectly couples the following devices: memory 112, one or more processors 114, one or more presentation components 116, input/output (I/O) ports 118, input/output components 120, and an illustrative power supply 122. The bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be gray and fuzzy. For example, one may consider a presentation component 116 such as a display device to be an I/O component. Also, processors 114 have memory 112. It will be understood by those skilled in the art that such is the nature of the art, and, as previously mentioned, the diagram of FIG. 1 is merely illustrative of an exemplary computing device that can be used in connection with one or more embodiments of the invention. Distinction is not made between such categories as “workstation,” “server,” “laptop,” “handheld device,” etc., as all are contemplated within the scope of FIG. 1, and are referenced as “computing device.”

The computing device 100 can include a variety of computer-readable media. By way of example, and not limitation, computer-readable media may comprise RAM; ROM; EEPROM; flash memory or other memory technologies; CDROM, DVD or other optical or holographic media; magnetic cassettes, magnetic tape, magnetic disk storage or other magnetic storage devices, or similar tangible media that are configurable to store data and/or instructions relevant to the embodiments described herein.

The memory 112 includes computer-storage media in the form of volatile and/or nonvolatile memory. The memory 112 may be removable, non-removable, or a combination thereof. Exemplary hardware devices include solid-state memory, hard drives, cache, optical-disc drives, etc. The computing device 100 includes one or more processors 114, which are operative to read data from various entities such as the memory 112 or the I/O components 120. The presentation component(s) 116 are operative to present data indications to a user or other device. Exemplary presentation components 116 include a display device, speaker, printing component, vibrating component, and the like.

The I/O ports 118 are operative to logically couple the computing device 100 to other devices including the I/O components 120, some of which may be built in. Illustrative I/O components 120 include a microphone, joystick, game pad, satellite dish, scanner, printer, wireless device, etc.

The components described above in relation to the computing device 100 may also be included in a wireless device. A wireless device, as described herein, refers to any type of wireless phone, handheld device, personal digital assistant (PDA), BlackBerry®, smartphone, digital camera, or other mobile devices (aside from a laptop), which are operable to communicate wirelessly. One skilled in the art will appreciate that wireless devices will also include a processor and computer-storage media, which are operable to perform various functions. Embodiments described herein are applicable to both a computing device and a mobile device. In embodiments, computing devices can also refer to devices which operate to run applications of which images are captured by the camera in a mobile device.

The computing system described above is configured to be used with cashback rebate system and method embodiments of the invention. Embodiments of the invention provide a programmatic approach that helps merchants determine the optimal rebate rates to offer consumers in order to maximize the merchants' sales or profits while meeting their business goals. Embodiments of the invention take into account the amount of revenue available for rebate distribution and the factors that influence consumer demand on sales rebate rates. Embodiments of the invention provide an optimal balance between providing the highest sales rebate percentages to consumers within the confines of an advertising merchant's available rebate budget.

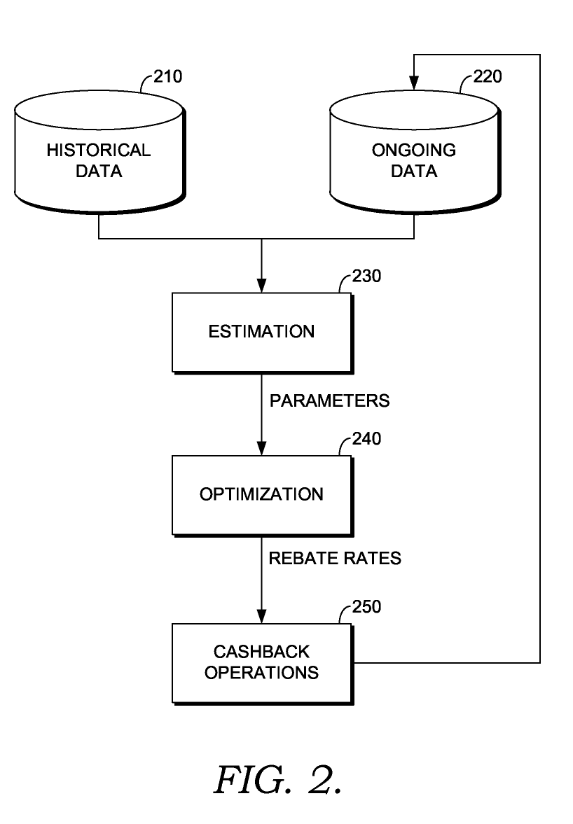

With reference now to FIG. 2, a block diagram illustrating the basic functionality of embodiments of the invention is shown. Embodiments of the invention utilize a statistical framework to estimate the factors that affect consumers relative to sales rebate rates offered for different products and services. The illustrated functionality includes data collection and/or receipt, i.e., using a historical data store 210 and an ongoing data store 220. The historical data store 210 includes historical sales data, historical price data and historical rebate data obtained from transaction logs, click logs, and other data sources, and is used to determine the influence of changes in price, rebate rates, and other factors, such as seasonality. The ongoing data store 220 includes sales, price and/or rebate data from recent operations and transactions, and is continually updated, e.g., at regular intervals. While the historical data store 210 and the ongoing data store 220 are illustrated in FIG. 2 as separate data store components, it will be understood and appreciated by those of ordinary skill in the art that all referenced data may be stored in association with a single data store, if desired. Further, the data store(s) may be separate components, as illustrated, or maintained in association with one or more computing devices. Any and all such variations, and any combination thereof, are contemplated to be within the scope of embodiments of the present invention.

In embodiments, in order to obtain more accurate sales rebate rates, the products and/or services offered for sale can be divided into categories, if there are multiple products and/or services available. The most common category would be according to subject matter, such as clothes, books, tools, electronics, as well as numerous other categories. Products or services within the same category generally should be similar in the way in which demand reacts to changes in prices and rebates for those products or services.

The historical data, e.g., click logs data, is used to provide an estimate of the gross earnings to be received from merchant advertising, for instance, using an interconnected computing network, such as the Internet. This estimation may be determined utilizing estimation component 230. Such gross earnings may then be utilized to calculate a rebate budget as a portion thereof that may be returned to consumers through rebate sales offers.

The parameters (e.g., gross earnings, rebate budget and the like) are then utilized to determine optimal sales rebate rates to offer consumers for one or more products. Such determination may be made utilizing optimization component 240. Cashback operations 250 may then be instituted according to the optimal rates determined by the optimization component 240. Data from cashback operations 250 is continually fed back to the ongoing data store 220 in a feedback loop, in order to provide up-to-date estimation parameters and optimization rebate rates.

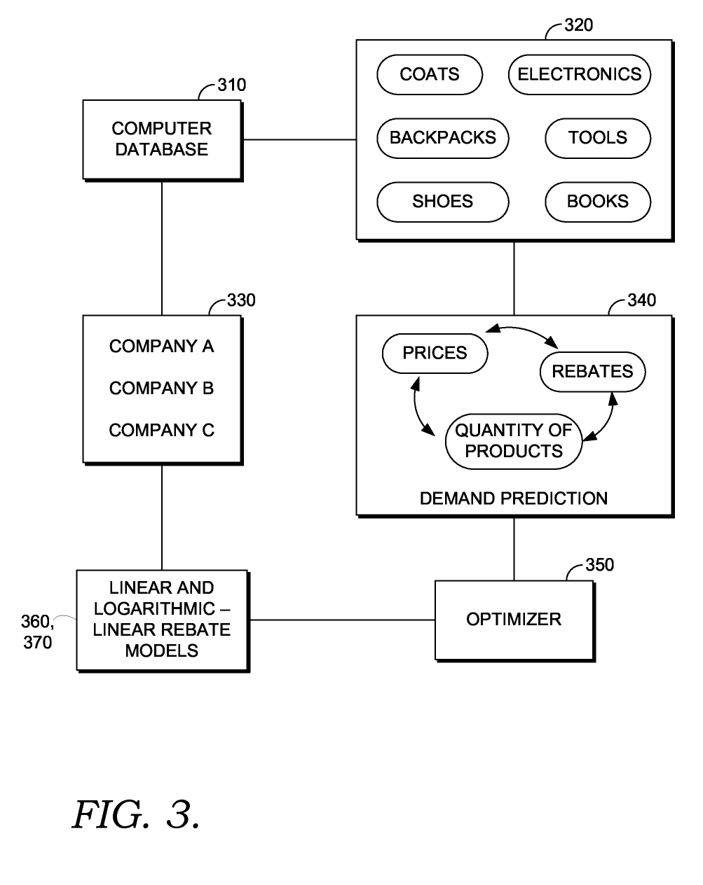

FIG. 3 is a block diagram of a computer system for implementing embodiments of the invention. A computing system, such as that described above with reference to FIG. 1 is used, along with one or more databases, designated together as reference numeral 310. The database(s) include, but not limited to, historical sales data, historical price data, and historical rebate data. Ongoing data is also stored in a database of the computing system, as described above with reference to FIG. 2.

Categories of products and services that will be offered for sale are established, as designated by reference numeral 320. The categories 320 shown in FIG. 3 are merely exemplary of numerous possible categories, and are not intended to limit the scope of embodiments of the invention. At one extreme, a category may be considered to be all products that a particular merchant sells. At the other extreme, each product may be considered its own category. More refined categories are better tuned with specific consumer behavior, and are therefore, better able to adapt rebate rates to stimulate sales. However, if categorization is too refined, then there may not be enough data to achieve a good estimate of consumer behavior to prices and rebates. Ideally, products and services within the same category should be similar in the way in which demand reacts to changes in prices and rebates for those products or services. For each category, a separate estimate of the influence of demand to prices and rebates is used as input to determine the optimal sales rebate, as more fully described below.

In the optimal sales rebate system, a host infrastructure works in conjunction with one or more merchants, designated as 330 in FIG. 3. Each of the merchants 330 has one or more categories 320 of products and/or services to offer for sale. In one embodiment of the invention, the host infrastructure would charge each merchant for advertising on the domain of the host infrastructure. A cost-per-click method could be utilized, as one example, in which a merchant pays the host infrastructure a fee for each time that a user clicks on that merchant's advertisement. A portion of the fees collected by the host infrastructure could be returned to the users in the form of cashback rebates.

A demand prediction component 340 is operable to determine the various relationships between prices, rebates offered, and quantity of products sold. The demand prediction component 340 utilizes historical and current data (e.g., received from the historical data store 210 and the ongoing data store 220 illustrated in FIG. 2), to determine an available rebate budget and the availability of products for sale for each merchant. The rebate budget is a percentage of the gross receipts that a merchant is willing to return to consumers in the form of cashback rebates. The rebate budget includes the portion of gross earnings collected by the infrastructure from advertising click monies and returned to consumers in the form of cashback rebates. Regression analysis can be used to estimate a statistical relationship between demand, price, sales rebate rates, and other factors. In one embodiment of the invention, a linear model is used. In another embodiment of the invention, a logarithmic-linear model is used.

A linear model of regression analysis is given by the following equation to predict the parameter of quantity of products sold (q) as a function of the parameter of time (t):

q(t)=βₒ+β₁p(t)+β₂r(t)+other factors+ε(t)

where the parameter p(t) is defined as the price of a good at time t, r(t) is defined as the parameter of rebate (%) offered for a good at time t, βₒ is an intercept constant based upon the sales, price, and rebate variables, β₁ is a price elasticity coefficient, and β₂ is the effect of demand to rebates. The “other factors” portion of the equation may include seasonal factors or product novelty factors, as two examples. The “other factors” portion could also be used as demand relationships that should be considered, in addition to prices and rebates. ε(t) is used for any significant anomalies, such as noise.

A logarithmic-linear model of regression analysis is given by the following equation to predict the quantity of products sold (q) as a function of time (t):

log q(t)=βₒ+β₁ log p(t)+β₂ log r(t)+other factors+ε(t)

Another component of the computer system is an optimizer 350. Certain modifications and enhancements are made to the demand prediction model 340 in order to obtain optimal rebate rates. An iteration process, such as second order cone programming or convex programming can be used in order to make more accurate estimates on rebate rates.

In order to simplify working with the above calculations, an assumption can be made that the price, p(t) and the rebate rate, r(t) remain constant during a specified time period. The specified time period will be selected as the maximum period of time in which a particular category maintains a constant price and constant rebate rate, as determined from the historical data store 210 and the ongoing data store 220.

Using the above assumptions, as an illustration for a single product case, the following optimal rebate rates can be derived. A linear rebate model 360 can be calculated using a quadratic equation. The linear rebate model 360 can be calculated from:

pβ₂r²+(pβₒ+p²β₁)r−E=0

where E is defined as the available rebate budget. This leads to a linear rebate rate equation of:

$$r = \frac{- ( p {β}_{0} + {p}^{2} {β}_{1} ) + \sqrt{{( p {β}_{0} + {p}^{2} {β}_{1} )}^{2} + 4 p {β}_{2} E}}{2 p {β}_{2}}$$

If another assumption is made, in which all of the available rebate budget is returned to customers as rebates, then the optimal linear rebate rate equation is reduced to:

$$r = \frac{1}{2} - \frac{{β}_{0} + p {β}_{1}}{2 {β}_{2}}$$

A logarithmic-linear rebate model 370 can also be calculated from the previous logarithmic-linear equation for the quantity of goods sold, and by using the same assumptions above as for the linear rebate model 360. The optimal logarithmic-linear rebate rate equation is:

$$r = \frac{{β}_{2}}{{β}_{2} + 1}$$

The method can be generalized to any number of products to which the optimal solution can be computed using an iterative process, such as convex programming.

An analysis of the linear rebate model results and the logarithmic-linear rebate model results is conducted to determine which model is a more accurate mathematical fit, and therefore, a more reliable predictor of the best rebate rate to use for a particular category. An accurate mathematical fit can be defined as data which tends to follow a clustered pattern and does not have a lot of extraneous solitary data. It may be deemed necessary to include “other factors” in addition to price and rebate rate, or to include certain anomalies that were previously assumed to be unimportant in the demand prediction model 340.

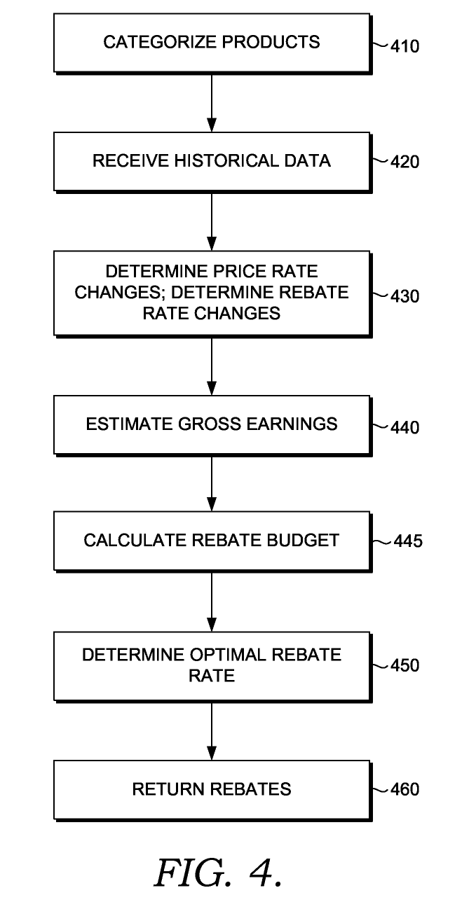

FIG. 4 is a flow diagram illustrating a method and a computer-implemented method for determining optimal sales rebate rates, in accordance with the invention. Each product and/or service for sale will be classified in step 410. A merchant may elect to classify everything together as a single category, or to establish several categories. As described above with reference to FIG. 3, products and services within the same category should be similar in the way in which demand reacts to changes in prices and rebates for those products or services. If desired, categories can be established according to parameters such as high-end or low-end items, or any other parameter that is subject to customer preferences.

Historical data from several sources is received into databases of a computing system in step 420. In addition to receiving historical sales data, historical price data, and historical rebate data, any other historical data of special interest that may influence the buying patterns of potential customers can be used.

All of the collected historical data, along with ongoing current data is used to determine the changes in price rates and rebate rates in step 430. The availability of products for sale for all merchants is determined. A demand prediction computing component utilizes the parameters of price and rebate offered for a particular product at a particular time. It also considers the parameters of the individual cost of a product and the quantity of products sold at a particular time. Regression analysis can be utilized to formulate a statistical relationship between demand, price, sales rebate rates, and other factors, such as a linear model or a logarithmic-linear model.

Gross earnings from merchant advertising are estimated in step 440. Historical data from Internet click logs is used to provide an estimate of the proceeds to be received from merchant advertising. From these calculations, a rebate budget can be determined for each merchant in step 445. The rebate budget is calculated as a certain percentage of the gross earnings that are available as a cashback to the consumer. Each merchant will determine the amount of the cashback percentage.

Optimal rebate rates can then be determined in step 450 for a linear rebate rate and a logarithmic-linear rebate rate, using the equations described above with reference to FIG. 3. An iteration process, such as second order cone programming or convex programming can be utilized to calculate an optimal rebate rate. A mathematical analysis of the results of both linear and logarithmic-linear models will determine the more appropriate model to use in determining a final optimal rebate rate.

Rebates will be offered to customers, based upon the policies agreed to by each merchant with the hosting infrastructure. The rebate offers may be limited to the rebate budget of fees collected, or merchants can elect to offer an additional amount as part of the rebate.

The above described method with reference to FIG. 4 can be used as an optimal sales rebate system in areas other than, or in addition to a computing environment. One alternative embodiment of the method described above could be used with newspaper advertising or flyer advertising. As one example, a particular store could offer rebates through either newspaper or flyer advertising. The collection of historical and current data, along with calculating an optimal rebate rate, using the above described linear and logarithmic-linear models would be applicable in the above described alternative embodiment, as well as the estimation of a statistical relationship between demand, price, and sales rebate rates. Another example would be a collection of stores, such as a mall, using the above described methods to calculate an optimal rebate rate. The optimal sales rebate system described herein would be applicable for many other business applications, as well.

The invention could also include non-computing advertising systems, such as a newspaper, magazine, social club, bulletin boards, or word of mouth, as well as many other systems. The infrastructure could be a search engine, an advertising engine, a social website, a blog, a newspaper company, or any other real company, to name just a few.

The invention could also be used in a combination of computing and non-computing methods and systems. An alternative embodiment could incorporate advertising in a non-computing environment, and collecting data and calculating the optimal sales rebate rates in a computing environment. Another alternative embodiment could incorporate utilizing a computing environment, other than the Internet, such as an internal organizational network. The organizational network could be utilized for either the advertising segment or the calculating segment, or both.

Many different arrangements of the various components depicted, as well as embodiments not shown, are possible without departing from the spirit and scope of the invention. Embodiments of the invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the embodiments of the invention.

It will be understood that certain features and subcombinations are of utility and may be employed without reference to other features and subcombinations and are contemplated within the scope of the claims. Not all steps listed in the various figures need be carried out in the specific order described.

The invention claimed is:

1. One or more computer-readable storage media that, when executed by a computing device, perform a method for determining optimal sales rebate rates, the method comprising:
receiving one or more of historical sales data, historical price data, and historical rebate data for a plurality of products advertised by a merchant;
determining patterns in demand, price, and sales rebate rates using the one or more of the historical sales data, the historical price data, and the historical rebate data;
predicting demand for each of the plurality of products; and
determining an optimal sales rebate rate for each of the plurality of products, wherein one of sales and profits of the plurality of products is maximized, and constraints are satisfied.

2. The one or more computer-readable storage media of claim 1, further comprising categorizing the plurality of products.

3. The one or more computer-readable storage media of claim 1, wherein determining the optimal sales rebate rate for each of the plurality of products comprises determining the optimal sales rebate rate utilizing an iteration process.

4. The one or more computer-readable storage media of claim 3, wherein determining the optimal sales rebate rate for each of the plurality of products utilizing the iteration process comprises determining the optimal sales rebate rates utilizing convex programming.

5. The one or more computer-readable storage media of claim 4, further comprising selecting at least one time period during which each of the respective price rates and respective rebate rates remain constant.

6. The one or more computer-readable storage media of claim 1, further comprising:
estimating gross earnings to be received from the merchant advertising the plurality of products; and
calculating a rebate budget as a portion of the estimated gross earnings, wherein the rebate budget is not exceeded.

7. The one or more computer-readable storage media of claim 1, wherein predicting demand for each of the plurality of products comprises determining a relationship between at least one price received as part of the historical price data, at least one prior rebate offer received as part of the historical rebate data, and a quantity of each of the plurality of products sold as evidenced by the historical sales data.

8. The one or more computer-readable storage media of claim 7, wherein predicting demand for each of the plurality of products comprises predicting demand utilizing a regression analysis process.

9. The one or more computer-readable storage media of claim 8, wherein predicting demand utilizing the regression analysis process comprises predicting demand utilizing a linear model.

10. The one or more computer-readable storage media of claim 8, wherein predicting demand utilizing the regression analysis process comprises predicting demand utilizing a logarithmic-linear model.

11. The one or more computer-readable storage media of claim 9, wherein determining the optimal sales rebate rate for each of the plurality of products comprises determining the optimal sales rebate rate utilizing a mathematical function of at least one of a price elasticity coefficient and a rebate demand factor.

12. The one or more computer-readable storage media of claim 9, wherein determining the optimal sales rebate rate for each of the plurality of products comprises determining the optimal sales rebate rate by solving a quadratic equation.

13. The one or more computer-readable storage media of claim 10, wherein determining the optimal sales rebate rate for each of the plurality of products comprises determining the optimal sales rebate rate using a mathematical function of a rebate demand factor.

14. In a computer system having a processor, memory and data storage subsystems, a computer-implemented optimal sales rebate system, comprising:
a data store comprising historical sales data, historical price data, and historical rebate data from one or more merchants;
a demand prediction computing component, wherein the demand prediction computing component is configured to determine a relationship between prices, rebates offered, and quantity of products sold utilizing the historical sales data, the historical price data, and the historical rebate data in the data store; and
an optimization computing component, comprising a gross earnings determining component and a rebate budget determining component, wherein the optimization computing component is configured to determine an optimal sales rebate rate for each of the plurality of products.

15. The system of claim 14, wherein the demand prediction computing component utilizes regression analysis.

16. The system of claim 14, wherein the optimization computing component utilizes convex programming.

17. The system of claim 14, wherein the optimization computing component is further configured to determine the optimal sales rebate rate for each of the plurality of products using one of a linear model and a logarithmic-linear model.

18. The system of claim 17, wherein if the optimization computing component determines the optimal sales rebate rate for each of the plurality of products using the optimal sales rebate rate linear model, the optimal sales rebate rate for each of the plurality of products is determined using a mathematical analysis of linear equation results, and wherein if the optimization computing component determines the optimal sales rebate rate for each of the plurality of products using the optimal sales rebate rate logarithmic-linear model, the optimal sales rebate rate for each of the plurality of products is determined using a mathematical analysis of logarithmic-linear equation results.

19. A computer-implemented method for determining optimal sales rebate rates, said method comprising:
receiving historical sales data, historical price data, and historical rebate data for a plurality of products advertised by a merchant;
utilizing a first computing process, determining a relationship between prices, rebates offered, and quantity of products sold utilizing a regression analysis;
utilizing a second computing process, estimating gross earnings to be received from the merchant advertising the plurality of products;
utilizing a third computing process, calculating a rebate budget as a portion of the estimated gross earnings; and
utilizing a fourth computing process, determining an optimal rebate rate for each of the plurality of products utilizing a second order cone programming, wherein one of sales and profits of the plurality of products is maximized, and wherein the rebate budget is not exceeded.

20. The computer-implemented method of claim 19, wherein determining the relationship between prices, rebates offered, and quantity of products sold utilizing the regression analysis comprises determining the relationship utilizing one of a linear model and a logarithmic-linear model.
